(19) United States
(12) Patent Application Publication
(10) Pub. No.: US 2026/0083086 A1
(43) Pub. Date: Mar. 26, 2026

(54) PET LITTER BOX

(71) Applicant: Jinsheng LI, Chaozhou City (CN)

(72) Inventor: Jinsheng LI, Chaozhou City (CN)

(21) Appl. No.: 19/403,294

(22) Filed: Nov. 28, 2025

(30) Foreign Application Priority Data
Jul. 15, 2025 (CN) 202510979464.X

(51) Int. Cl. A01K 1/01

(52) U.S. Cl. CPC A01K 1/0107

(57) ABSTRACT

A pet litter box, including: a main body, the main body is defined with a first accommodating slot and a first opening. A supporting assembly includes a seat and a limiting wall connected to the seat; the seat is connected to a wall, and the limiting wall includes a first abutting position and a second abutting position. An abutting portion is provided on an outwardly extending edge of the cover. When the cover is connected to the main body, the protrusion abuts against a side of the abutting portion, and a side of the abutting portion closer to the main body abuts against the seat, to lead the cover fix relative to the main body. A second opening is defined; when the cover is connected to the main body, the second opening is configured to allow pets to enter and exit the first receiving slot.

### CROSS-REFERENCE TO RELATED APPLICATIONS

This disclosure claims foreign priority of Chinese Patent disclosure No. 202510979464.X, filed on Jul. 15, 2025 in the China National Intellectual Property Administration, the disclosures of all of which are hereby incorporated by reference

### TECHNICAL FIELD

The present disclosure relates to the technical field of pet supplies, in particular to a pet litter box.

### BACKGROUND

With the increasing number of pets being raised each year, pet litter boxes, as essential equipment for maintaining a clean-living environment for pets and household hygiene, have attracted widespread attention regarding their design rationality and user-friendliness. Currently, common pet litter boxes (such as pet toilets, litter boxes, etc.) typically include a main structure for holding pet litter box or bedding, along with a lid that can be opened and closed to cover the interior space. This design helps reduce odor diffusion and provides pets with a relatively private environment.

At present, the connection methods between the lid and the main structure of pet litter boxes in the market often use structures such as latches, magnetic attachments, threaded couplings, or simple overlaps. However, these connection methods have certain drawbacks: for example, latch structures tend to loosen over time due to wear, making it easy for the lid to fall off; magnetic structures are limited by magnetic strength, and when the pet bumps into or touches it with external force, there may be a risk of instability; threaded coupling structures, though stable, are cumbersome to assemble and disassemble, making daily cleaning and maintenance inconvenient; and simple overlapping structures lack effective positioning, causing the lid to shift and making it difficult to form a reliable seal.

To address these issues, this disclosure provides a pet litter box that can effectively solve the above problems. It features a secure connection, easy assembly and disassembly, and provides convenient access for pets.

### SUMMARY

In order to overcome the shortcomings of existing technology, the present disclosure provides a pet litter box that is firmly connected, easy to disassemble and assemble, and can also facilitate the entry and exit of pets.

To realize the above objective, the present disclosure provides a pet litter box, including: a main body, wherein the main body is defined with a first accommodating slot and a first opening communicating with the first accommodating slot; a supporting assembly, wherein the supporting assembly comprises a seat and a limiting wall connected to the seat; the seat is connected to a wall forming a first opening, and the limiting wall comprises a first abutting position and a second abutting position, both of which are each provided with a protrusion; a cover, wherein an abutting portion is provided on an outwardly extending edge of the cover; when the cover is connected to the main body, the protrusion abuts against a side of the abutting portion that faces away from the main body, and a side of the abutting portion closer to the main body abuts against the seat, to lead the cover fix relative to the main body; the cover and/or the main body is defined with a second opening; when the cover is connected to the main body, the second opening is configured to allow pets to enter and exit the first receiving slot.

Furthermore, a contour of the cover is corresponded to a contour of the limiting wall.

Furthermore, the overall contour of the limiting wall is rectangular, the first abutting position is corresponded to one vertex of the rectangle, and the second abutting position is corresponded to another vertex of the rectangle, with both vertices located on a same diagonal line.

Furthermore, the limiting wall further comprises a third abutting position, and the third abutting position is provided with the protrusion; when the cover is connected to the main body, the protrusion located at the third abutting position abuts against the side of the abutting portion that faces away from the main body.

Furthermore, the cover is provided with a second accommodating slot, and the second opening is located on a wall forming the second accommodating slot; the second opening is communicated with the second accommodating slot; when the cover is connected to the main body, the second accommodating slot communicates with the first accommodating slot.

Furthermore, the cover is also defined with a third opening, which is located on another wall of the second accommodating slot, and the third opening and the second opening are located on walls on opposite sides of the second accommodating slot, with the third opening communicating with the second accommodating slot.

Furthermore, the limiting wall is perpendicular to the seat and located at an edge of the seat, and limiting wall is extended outward from the main body.

Furthermore, an edge of the wall forming the second opening is wrapped with a cut-resistant pad.

Furthermore, the protrusion is in a semi-circular shape.

Furthermore, top corners of the main body are rounded.

The present disclosure further provides a pet litter box, including: a main body, wherein the main body is defined with a first accommodating slot and a first opening communicating with the first accommodating slot; an edge of a wall forming the first opening extends outward to form a seat and a limiting wall connected to the seat; the limiting wall comprises a first abutting position and a second abutting position, both of which are each provided with a protrusion; a cover, wherein the cover is provided with an abutting portion on an outwardly extending edge; when the cover is connected to the main body, the protrusion abuts against a side of the abutting portion that faces away from the main body, and a side of the abutting portion closer to the main body abuts against the seat, to lead the cover fix relative to the main body; the cover and/or the main body is defined with a second opening; when the cover is connected to the main body, the second opening is configured to allow pets to enter and exit the first receiving slot.

Furthermore, a contour of the cover is corresponded to a contour of the limiting wall.

The pet litter box is stably connected, easy to disassemble and assemble, and also facilitates the entry and exit of pets.

### BRIEF DESCRIPTION OF DRAWINGS

In order to more clearly illustrate the technical solutions in the embodiments of this disclosure, the following provides a brief introduction to the drawings required in the description of the embodiments. The drawings described below are merely some of the embodiments of this disclosure. For a person skilled in the art, without the need for inventive effort, other drawings can be derived from these drawings.

The following provides further explanation of this disclosure in conjunction with the drawings and embodiments.

FIG. 1 is a schematic structural diagram of an overall structure of a pet litter box from one angle according to a first embodiment of the present disclosure.

FIG. 2 is schematic structural diagram of an overall structure of the pet litter box from another angle according to the first embodiment of the present disclosure.

FIG. 3 is a first exploded diagram of the pet litter box.

FIG. 4 is a second exploded diagram of the pet litter box.

FIG. 5 is an enlarged view of an area A in FIG. 3.

FIG. 6 is an enlarged view of an area B in FIG. 3.

FIG. 7 is a top view of the pet litter box according the first embodiment of the present disclosure.

FIG. 8 is a cross-sectional view taken along line B-B in FIG. 7.

FIG. 9 is an enlarged view of an area C in FIG. 8.

FIG. 10 is a top view of the pet litter box according a second embodiment of the present disclosure.

FIG. 11 is a schematic structural diagram of an overall structure of a pet litter box according to the second embodiment of the present disclosure.

### DESCRIPTION OF THE REFERENCE NUMERAL

1 main body, 11 first accommodating slot, 12 first opening, 2 supporting assembly, 21 seat, 22 limiting wall, 22a protrusion, 221 first abutting position, 222 second abutting position, 223 third abutting position, 3 cover, 31 abutting portion, 32 second accommodating slot, 33 third opening, 4 second opening, 41 cut-resistant pad.

### DETAILED DESCRIPTION OF THE EMBODIMENTS

To make the objectives, features, and advantages of this disclosure more clearly understandable, the following detailed description of the specific implementation of the disclosure is provided with reference to the accompanying drawings. Many specific details are elaborated in the following description to facilitate a full understanding of the disclosure.

However, the disclosure can be implemented in many different ways that are not limited to the descriptions provided herein, and skilled personnel in the field can make similar improvements without departing from the scope of the disclosure. Therefore, the disclosure is not limited by the specific embodiments disclosed below.

In the description of this disclosure, it is necessary to understand that when the following terms appear—“center,” “longitudinal,” “lateral,” “length,” “width,” “thickness,” “top,” “bottom,” “front,” “back,” “left,” “right,” “vertical,” “horizontal,” “top,” “bottom,” “inner,” “outer,” “clockwise,” “counterclockwise,” “axial,” “radial,” “circumferential,” etc.—these terms indicate directional or positional relationships based on the orientation or positional relationship shown in the drawings. They are used for the convenience of describing the disclosure and simplifying the description, and do not imply or suggest that the indicated device or component must have a specific orientation or be constructed and operated in a specific orientation. Therefore, they should not be construed as limiting the scope of the disclosure.

Furthermore, when the terms “first” and “second” appear, these terms are used solely for descriptive purposes and should not be interpreted as indicating or implying relative importance or the implied number of technical features referred to. Therefore, features labeled “first” or “second” can explicitly or implicitly include at least one of the respective features. In the description of this disclosure, if the term “multiple” is used, it means at least two, such as two, three, etc., unless explicitly defined otherwise.

In this disclosure, unless explicitly specified otherwise, when terms such as “install,” “connected,” “joined,” or “fixed” are used, these terms should be understood broadly. For example, it may refer to a fixed connection, a detachable connection, or an integral connection; a mechanical connection, an electrical connection; a direct connection, or an indirect connection via an intermediary medium. It can also refer to internal communication between two components or an interaction between two components unless explicitly stated otherwise. Skilled personnel in the field can understand the specific meaning of these terms in this disclosure based on the context.

Additionally, unless otherwise specified, if a first feature is described as being “on,” “above,” “below,” or in a similar way relative to a second feature, it means that the first and second features are in direct contact or in indirect contact through an intermediary medium. Furthermore, the term “above,” “on top,” or “over” may mean that the first feature is directly or obliquely above the second feature, or merely that the first feature has a greater height than the second feature. Similarly, “below,” “under,” or “beneath” may mean that the first feature is directly or obliquely below the second feature, or merely that the first feature has a lower height than the second feature.

It should be understood that when a component is said to be “fixed to” or “arranged on” another component, it may either be directly on the component or positioned within a central component. When one component is considered to be “connected” to another component, it may be directly connected or may also be located within a central component. The terms “vertical,” “horizontal,” “up,” “down,” “left,” “right,” and similar expressions used in this disclosure are for illustrative purposes and do not necessarily indicate the only possible implementation.

### Embodiment 1

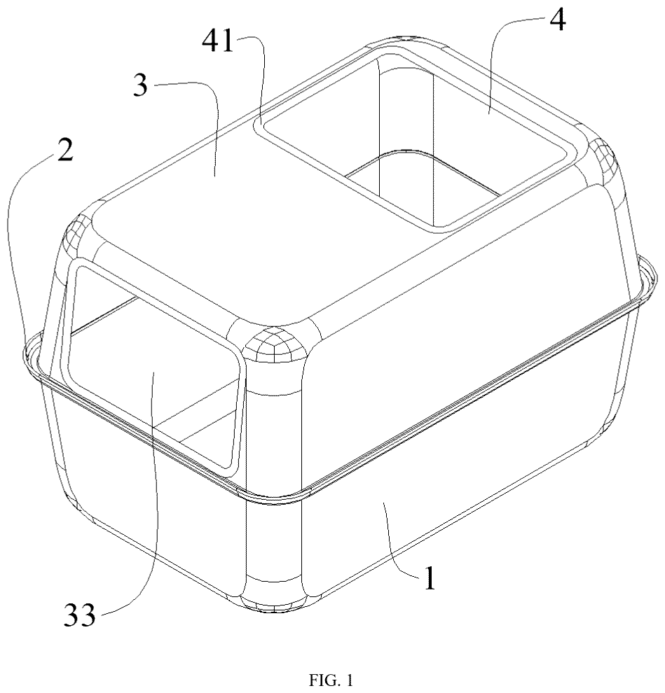

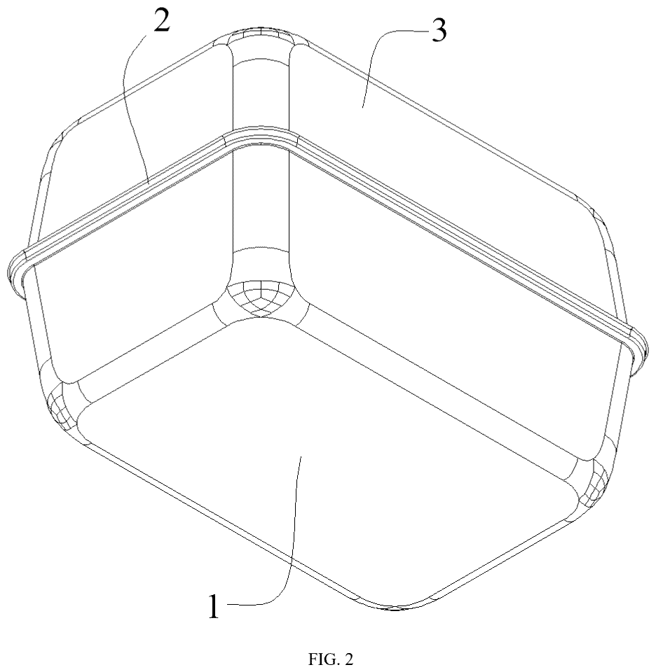

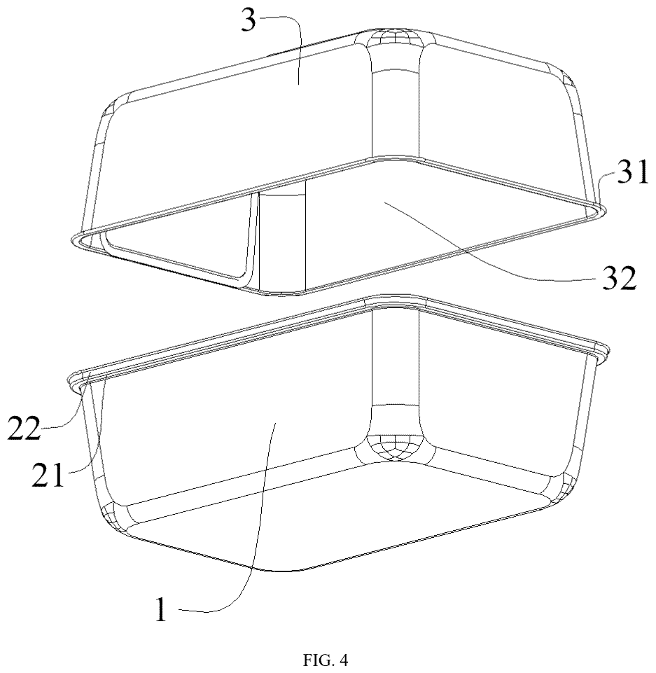

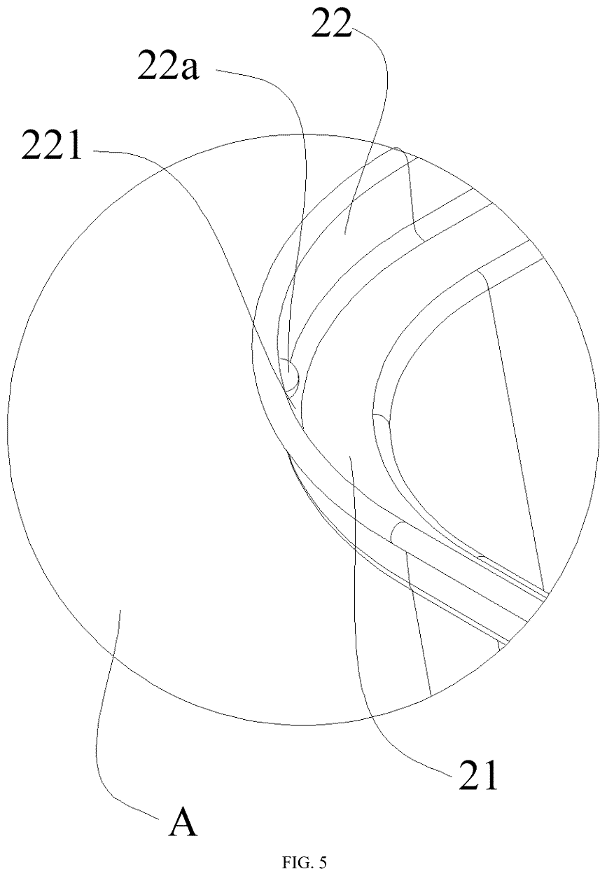

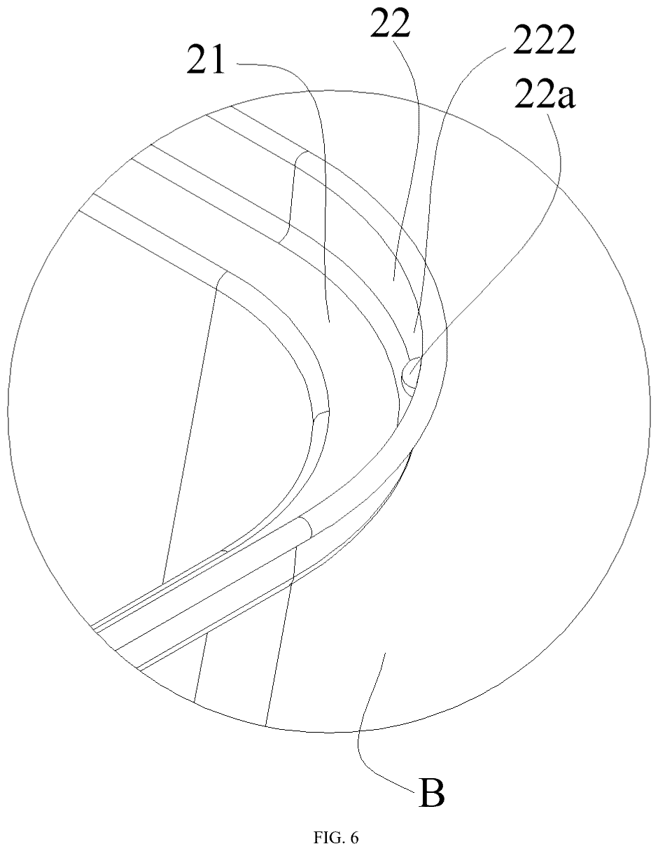

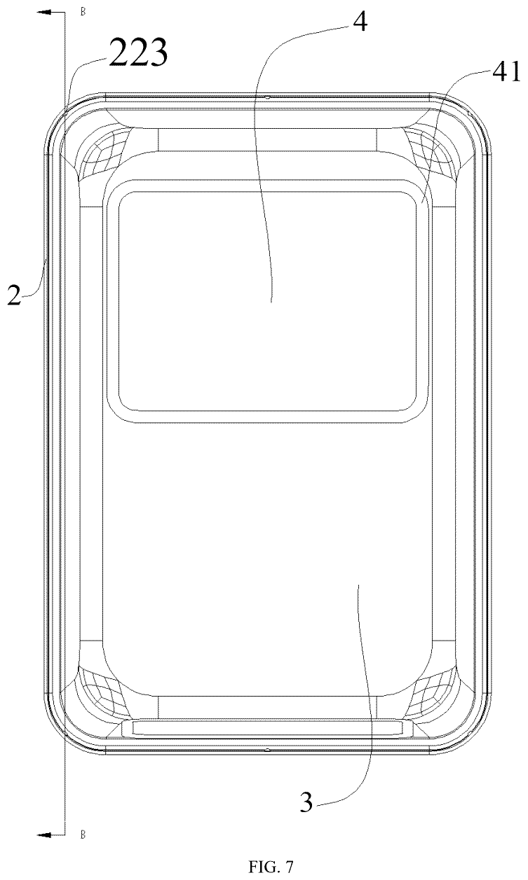

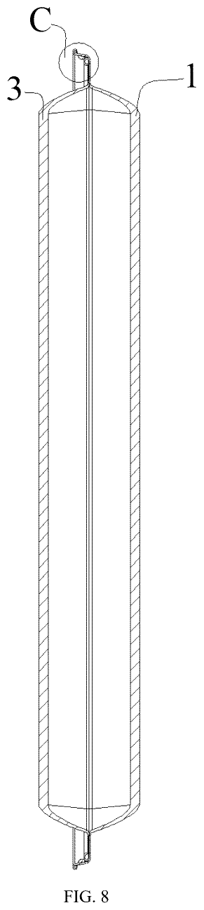

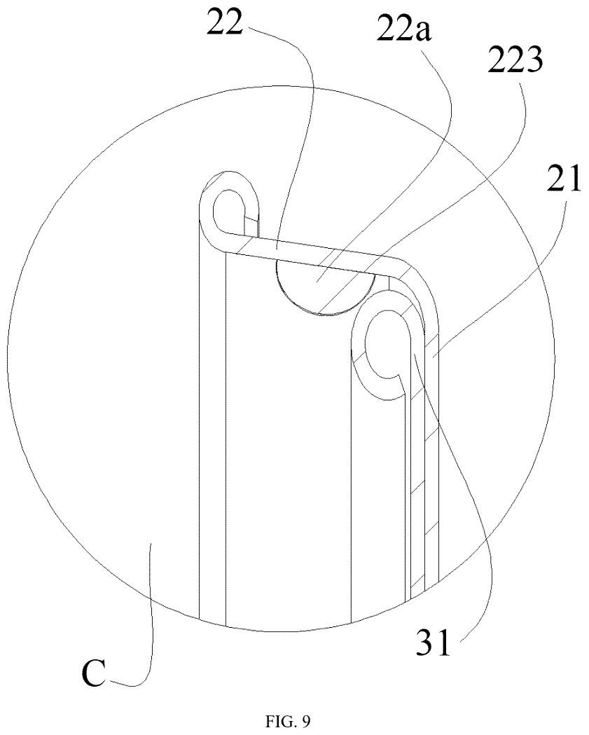

Referring to FIGS. 1 to 9, a pet litter box includes: a main body 1, a bearing Assembly 2 and a cover 3.

The main body 1 is equipped with a first receiving slot 11 and a first opening 12 that communicates with the first receiving slot 11.

The bearing assembly 2 includes a seat 21 and a limiting wall 22 connected to the seat 21. The seat 21 is connected to the wall forming the first opening 12. The limiting wall 22 includes a first abutting position 221 and a second abutting position 222, each having a projection 22a.

An abutting portion (31) is provided on an outwardly extending edge of the cover 3.

When the cover 3 is connected to the main body 1, the projection 22a abuts against the side of the abutment section 31 opposite the main body 1. The side of the abutment section 31 closer to the main body 1 abuts against the seat 21 to fix the cover 3 relative to the main body 1.

The cover 3 and/or the main body 1 is defined with a second opening 4. When the cover 3 is connected to the main body 1, the second opening 4 allows pets to enter and exit the first receiving slot 11.

This structure provides a pet litter box that is firmly connected, easy to assemble and disassemble, while also allowing easy pet access.

The pet litter box described in the first embodiment can be used as a litter box by laying cat litter in the first receiving slot 11, allowing the cat to enter through the second opening 4 when needed, and exit through the second opening 4 after use. The pet litter box can also serve as a pet toilet by placing other items such as absorbent pads in the first receiving slot 11.

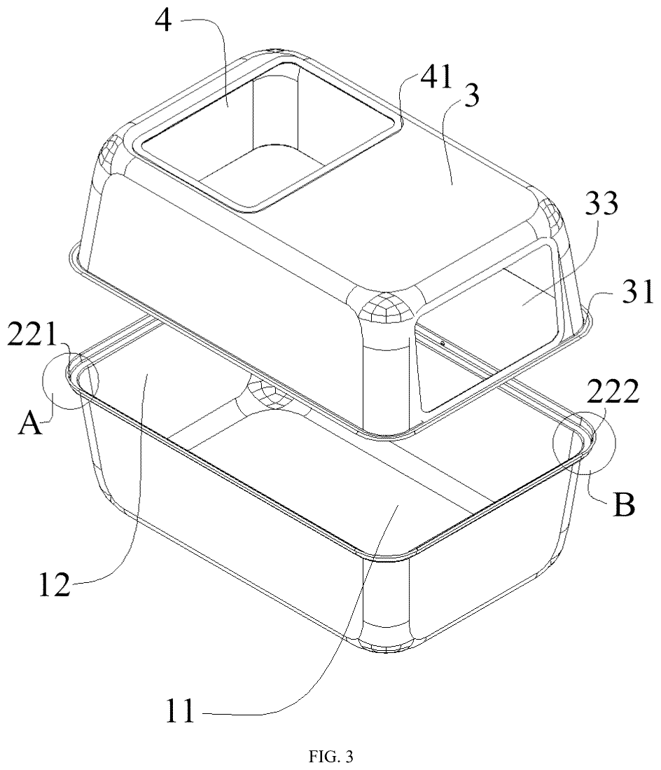

It should be understood that when the projection 22a is located at the first abutting position 221 and the second abutting position 222, the projection 22a can abut against the side of the abutment section 31 opposite the main body 1, fixing the cover 3 relative to the main body. For example, as shown in FIG. 3, when the limiting wall 22 and the cover 3 have a rectangular overall shape, the first abutting position 221 corresponds to one vertex of the rectangle, and the second abutting position 222 corresponds to the other vertex. The two vertices lie on the same diagonal. When the limiting wall 22 and the cover 3 have a circular overall shape, the first abutting position 221 corresponds to a point on the circular edge, and the second abutting position 222 corresponds to another point on the same diameter of the circular edge as the first abutting position 221. Additionally, the limiting wall 22 and cover 3 could have other polygonal shapes, such as pentagons or hexagons, as long as these shapes allow the projection 22a to be positioned at the first and second positions for fixing the cover 3 relative to the main body 1. Preferably, the first abutting position 221 and second abutting position 222 are located on opposite parts of the limiting wall 22.

It should be understood that the carrying component 2 can either be integrally formed with the main body 1 or be detachably connected.

In this embodiment, a contour of the cover 3 corresponds to a contour of the limiting wall 22.

With the corresponding contours, when the cover 3 is connected to the main body 1, the corresponding contours allow for easy installation and positioning by the user. Additionally, the cover 3 naturally fits against the edge of the limiting wall 22 when installed, and no further adjustment is needed to align the abutting portion 31 precisely with the first abutting position 221 and second abutting position 222 on the limiting wall 22. Since the contours correspond, the edge of the cover 3 will also fit closely with the edge of the limiting wall 22, further restricting any horizontal (left/right or front/back) movement of the cover 3, reducing the risk of shaking or loosening when pets enter or exit. Moreover, when the cover 3 needs to be detached from the main body 1, the matching contours allow the user to quickly find the point of force and easily detach the cover, making it particularly suitable for pet owners who frequently need to disassemble and clean the pet litter box.

In this embodiment, the overall contour of the limiting wall 22 is rectangular, the first abutting position 221 is corresponded to one vertex of the rectangle, and the second abutting position 222 is corresponded to the other vertex, with both vertices located on a same diagonal line.

With the above structure, the first abutting position 221 and second abutting position 222 are symmetrically distributed. When the cover 3 is fixed by the protrusions 22a at these two points, the constraint forces on the cover 3 are symmetrically transmitted along the diagonal direction, ensuring that the cover 3 is evenly stressed overall. This helps avoid local looseness caused by displacement of the fixation points. For example, when a pet bumps into one side of the cover 3, the force is transmitted along the diagonal to both fixed points, rather than concentrating on one side, reducing localized wear on the individual protrusions 22a or the abutting portion 31, and extending the structural lifespan. Furthermore, because the diagonal distance is the longest in a rectangle, the torque during rotation is maximized, offering maximum resistance, which effectively limits the horizontal shift, front/back rocking, and rotational misalignment of the cover 3.

In this embodiment, the limiting wall 22 also includes a third abutting position 223, with a protrusion 22a provided at the third abutting position. The third abutting position 223 corresponds to a vertex that is not vertex of the first abutting position 221 or second abutting position 222. When the cover 3 is connected to the main body 1, the protrusion 22a at the third abutting position 223 contacts the side of the abutting portion 31 that faces away from the main body 1.

The first abutting position 221, second abutting position 222, and third abutting position 223 are located at the three vertices of the limiting wall 22, forming a triangular limiting structure. The protrusions 22a at these three vertices prevent the abutting portion 31 of the cover 3 from detaching upward, with the supporting force from the seat 21 ensuring the cover 3 is fixed by three points. Which effectively limits horizontal shifting, front/back rocking, or rotational misalignment of the cover 3, which is far superior to two-point fixation, greatly reducing the risk of the cover 3 loosening. When the cover 3 needs to be detached from the main body 1, the user only needs to detach from the vertex without the protrusion 22a, making disassembly convenient.

In this embodiment, the cover 3 is defined with a second receiving groove 32, and the second opening 4 is positioned on the wall forming the second receiving groove 32, communicating with the second receiving groove 32. When the cover 3 is connected to the main body 1, the second receiving groove 32 is connected to the first receiving groove 11.

The communication between the second receiving groove 32 and the first receiving groove 11 expands the available activity space for pets after entering the first receiving groove 11. For larger or more active pets, such as medium to small-sized dogs or cats, the larger space effectively reduces the sense of confinement, improving the comfort of using the pet litter box. Furthermore, when the pet litter box is used as a litter box, it also prevents the cat from scattering the litter during use.

In this embodiment, the cover 3 also defined with a third opening 33, located on a different side of the wall forming the second receiving groove 32 from the second opening 4. The third opening 33 communicates with the second receiving groove 32.

This structure provides more varied options for pets to enter and exit the pet litter box, allowing pets to choose a path based on their own needs.

In this embodiment, the limiting wall 22 is perpendicular to the seat 21 and located at the edge of the seat 21, extending away from the main body 1.

With this structure, physical blocking restricts the movement of the cover 3. When the cover 3 is placed on the seat 21, the perpendicular limiting wall 22 can catch the edge of the cover 3 from the side, preventing it from sliding or shifting along the surface of the seat 21 due to pet collisions, shaking, or external forces. The extending direction away from the main body 1 also matches the installation direction of the cover 3, ensuring the limiting wall 22 accurately aligns with the abutting portion 31, forming a bi-directional limit and making the connection between the cover 3 and the main body 1 more secure. This avoids gaps or detachment during use, especially in situations where active pets like puppies or kittens frequently enter and exit. When used as a litter box or pet toilet, it effectively prevents the spillage of pet urine.

In this embodiment, the edge of the wall forming the second opening 4 is wrapped with a cut-resistant pad 41.

With this structure, the cut-resistant pad 41 wraps around the edge of the wall forming the second opening 4, forming a cushioning layer that effectively eliminates the risk of pets being cut or scratched.

If the edge of the wall forming the second opening 4 is untreated, sharp corners, burrs, or rough edges caused by long-term use may exist. When pets enter or exit, rapid movements, rubbing, or scratching actions can cause contact with the edges. For example, when a cat uses its paws to scratch the edge of the opening, the sharp edges could injure the paw pads, or a dog's nose or abdomen may be scratched. By wrapping the edge of the wall forming the second opening 4 with the cut-resistant pad 41, a cushioning layer is created, effectively eliminating the risk of pets being cut or scratched.

### Embodiment 2

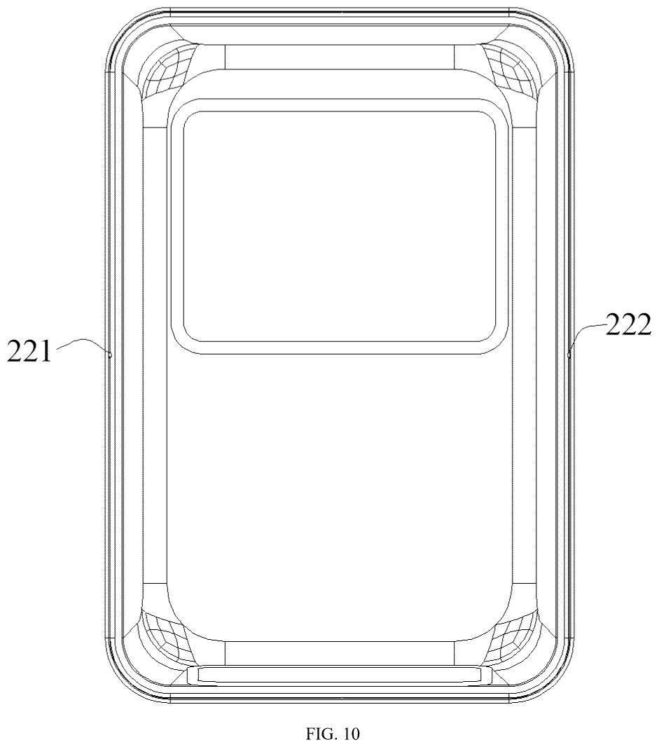

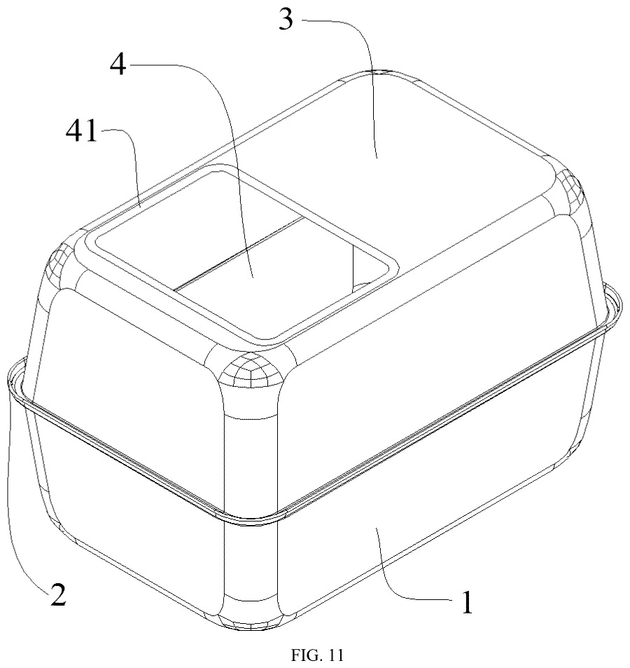

With reference to FIGS. 10 to 11, the pet litter box provided in this embodiment has the same basic structure, principles, and technical effects as the first embodiment. For the sake of brevity, any parts not mentioned in this embodiment can be referenced to the corresponding content in the first embodiment.

A pet litter box, including: a main body 1, a seat 21 and a limiting wall 22, and a cover 3.

The main body 1 is provided with a first accommodating slot 11 and a first opening 12 that communicates with the first accommodating slot 11.

The distinction from the embodiment 1 is that the edge of the wall forming the first opening 12 extends outward to form a bearing seat 21, which is connected to a limiting wall 22.

The limiting wall 22 includes a first abutting position 221 and a second abutting position 222. Both the first abutting position 221 and the second abutting position 222 are provided with protrusions 22a.

The edge of the cover 3 extends outward to form an abutting portion 31.

When the cover 3 is connected to the main body 1, the protrusions 22a abut against the side of the abutting portion 31 that faces away from the main body 1. The side of the abutting portion 31 that is closer to the main body 1 abuts against the bearing seat 21, thereby fixing the cover 3 relative to the main body 1.

The cover 3 and/or the main body 1 is defined with a second opening 4. When the cover 3 is connected to the main body 1, the second opening 4 communicates with the first accommodating slot 11, allowing the pet to enter and exit.

The pet litter box is stable in connection, easy to assemble and disassemble, and allows easy access for pets.

The pet litter box described in this disclosure can be used as a cat litter box by placing cat litter in the first accommodating slot 11. When a cat needs to use it, it can enter through the second opening 4 and leave through the second opening 4 after use. The pet litter box can also serve as a pet toilet by placing items such as absorbent pads inside the first accommodating slot 11.

It should be understood that when the protrusion 22a is located at the first abutting position 221 and the second abutting position 222, the protrusion 22a can abut against the abutting portion 31 on the side facing away from the main body 1, thus fixing the cover 3 relative to the main body. For example, when the limiting wall 22 and the cover 3 have an overall rectangular shape, the first abutting position 221 corresponds to one vertex of the rectangle, and the second abutting position 222 corresponds to another vertex of the rectangle, with both vertices located on the same diagonal. When the limiting wall 22 and the cover 3 have an overall circular shape, the first abutting position 221 corresponds to a point on the edge of the circle, and the second abutting position 222 corresponds to another point on the edge of the circle, on the same diameter as the first abutting position 221. Of course, the limiting wall 22 and the cover 3 can also have other polygonal shapes, such as pentagons or hexagons, as long as these shapes allow the protrusion 22a to fix the cover 3 relative to the main body when located at these two positions. Preferably, the first abutting position 221 and the second abutting position 222 are on two opposite parts of the limiting wall 22.

In this embodiment, the contour of the cover 3 is corresponded to the contour of the limiting wall 22. When the cover 3 is connected to the main body 1, the corresponding contours make it easy for users to install and position the cover. The cover 3 will naturally fit against the edge of the limiting wall 22 without extra adjustment, ensuring that the abutting portion 31 precisely aligns with the first and second abutting positions 221 and 222 on the limiting wall 22. The corresponding contours also ensure that the edge of the cover 3 fits completely against the edge of the limiting wall 22, further restricting lateral or longitudinal shifting of the cover 3 and reducing the risk of wobbling or detachment when the pet enters or exits. Additionally, when the cover 3 needs to be removed from the main body 1, the matching contours make it easy to find the point of force and remove the cover easily, which is particularly suitable for situations where pet owners need to frequently disassemble and clean the pet litter box.

In this embodiment, the limiting wall 22 has a rectangular shape, with the first abutting position 221 corresponding to the midpoint of one edge of the rectangle, and the second abutting position 222 corresponding to the midpoint of the other edge parallel to the first abutting position 221.

This structure ensures that the abutting portion 31 of the cover 3 receives more even pressure, preventing excessive force on one side that could cause the cover 3 to tilt or become loose, thus ensuring that the cover 3 remains securely fixed to the main body 1.

The embodiments above are provided in connection with specific content, and the implementation of this disclosure is not limited to these descriptions. Any methods or structures that are similar or equivalent to those described, or any technical improvements or substitutions based on the concepts of this disclosure, should be considered within the scope of protection of this disclosure.

What is claimed is:

1. A pet litter box, comprising:
a main body, wherein the main body is defined with a first accommodating slot and a first opening communicating with the first accommodating slot;
a supporting assembly, wherein the supporting assembly comprises a seat and a limiting wall connected to the seat; the seat is connected to a wall forming a first opening, and the limiting wall comprises a first abutting position and a second abutting position, both of which are each provided with a protrusion;
a cover, wherein an abutting portion is provided on an outwardly extending edge of the cover;
when the cover is connected to the main body, the protrusion abuts against a side of the abutting portion that faces away from the main body, and a side of the abutting portion closer to the main body abuts against the seat, to lead the cover fix relative to the main body;
the cover and/or the main body is defined with a second opening; when the cover is connected to the main body, the second opening is configured to allow pets to enter and exit the first receiving slot.

2. The pet litter box according to claim 1, wherein a contour of the cover is corresponded to a contour of the limiting wall.

3. The pet litter box according to claim 2, wherein the overall contour of the limiting wall is rectangular, the first abutting position is corresponded to one vertex of the rectangle, and the second abutting position is corresponded to another vertex of the rectangle, with both vertices located on a same diagonal line.

4. The pet litter box according to claim 3, wherein the limiting wall further comprises a third abutting position, and the third abutting position is provided with the protrusion; when the cover is connected to the main body, the protrusion located at the third abutting position abuts against the side of the abutting portion that faces away from the main body.

5. The pet litter box according to claim 1, wherein the cover is provided with a second accommodating slot, and the second opening is located on a wall forming the second accommodating slot; the second opening is communicated with the second accommodating slot;
when the cover is connected to the main body, the second accommodating slot communicates with the first accommodating slot.

6. The pet litter box according to claim 5, wherein the cover is also defined with a third opening, which is located on another wall of the second accommodating slot, and the third opening and the second opening are located on walls on opposite sides of the second accommodating slot, with the third opening communicating with the second accommodating slot.

7. The pet litter box according to claim 1, wherein the limiting wall is perpendicular to the seat and located at an edge of the seat, and limiting wall is extended outward from the main body.

8. The pet litter box according to claim 1, wherein an edge of the wall forming the second opening is wrapped with a cut-resistant pad.

9. The pet litter box according to claim 1, wherein the protrusion is in a semi-circular shape.

10. The pet litter box according to claim 1, wherein top corners of the main body are rounded.

11. A pet litter box, comprising:
a main body, wherein the main body is defined with a first accommodating slot and a first opening communicating with the first accommodating slot;
an edge of a wall forming the first opening extends outward to form a seat and a limiting wall connected to the seat;
the limiting wall comprises a first abutting position and a second abutting position, both of which are each provided with a protrusion;
a cover, wherein the cover is provided with an abutting portion on an outwardly extending edge;
when the cover is connected to the main body, the protrusion abuts against a side of the abutting portion that faces away from the main body, and a side of the abutting portion closer to the main body abuts against the seat, to lead the cover fix relative to the main body;
the cover and/or the main body is defined with a second opening; when the cover is connected to the main body, the second opening is configured to allow pets to enter and exit the first receiving slot.

12. The pet litter box according to claim 11, wherein a contour of the cover is corresponded to a contour of the limiting wall.

13. The pet litter box according to claim 12, wherein the overall contour of the limiting wall is rectangular, the first abutting position is corresponded to one vertex of the rectangle, and the second abutting position is corresponded to another vertex of the rectangle, with both vertices located on a same diagonal line.

14. The pet litter box according to claim 13, wherein the limiting wall further comprises a third abutting position, and the third abutting position is provided with the protrusion; when the cover is connected to the main body, the protrusion located at the third abutting position abuts against the side of the abutting portion that faces away from the main body.

15. The pet litter box according to claim 11, wherein the cover is provided with a second accommodating slot, and the second opening is located on a wall forming the second accommodating slot; the second opening is communicated with the second accommodating slot;
when the cover is connected to the main body, the second accommodating slot communicates with the first accommodating slot.

16. The pet litter box according to claim 15, wherein the cover is also defined with a third opening, which is located on another wall of the second accommodating slot, and the third opening and the second opening are located on walls on opposite sides of the second accommodating slot, with the third opening communicating with the second accommodating slot.

17. The pet litter box according to claim 11, wherein the limiting wall is perpendicular to the seat and located at an edge of the seat, and limiting wall is extended outward from the main body.

18. The pet litter box according to claim 11, wherein an edge of the wall forming the second opening is wrapped with a cut-resistant pad.

19. The pet litter box according to claim 11, wherein the protrusion is in a semi-circular shape.

20. The pet litter box according to claim 11, wherein top corners of the main body are rounded.
